(19) United States
(12) Patent Application Publication
(10) Pub. No.: US 2021/0142153 A1
(43) Pub. Date: May 13, 2021

(54) RESISTIVE PROCESSING UNIT SCALABLE EXECUTION

(71) Applicant: INTERNATIONAL BUSINESS MACHINES CORPORATION, Armonk, NY (US)

(72) Inventors: TAYFUN GOKMEN, Briarcliff Manor, NY (US); Abdullah Kayi, Westchester, NY (US)

(21) Appl. No.: 16/676,639

(22) Filed: Nov. 7, 2019

(51) Int. Cl. G06N 3/063; G06F 15/80; G06F 13/36; G06N 3/04; G06N 3/08

(52) U.S. Cl. CPC G06N 3/063; G06F 15/80; G06N 3/084; G06N 3/04; G06F 13/36

(57) ABSTRACT

Embodiments are directed to forming and training a resistive processing unit (RPU) system. The RPU system is formed from a plurality of RPU tiles, whereby the RPU tiles are the atomic building block of the RPU system. The plurality of RPU tiles is configured as a plurality of RPU chips. The plurality of RPU compute nodes is formed from the plurality of RPU chips. The plurality of RPU compute nodes can further be connected by a low latency, high speed network. The RPU system is trained for an artificial neural network model using the atomic matrix operations of a forward cycle, backward cycle, and matrix update.

### BACKGROUND

The present disclosure relates in general to novel configurations of trainable resistive crosspoint devices, which are referred to herein as resistive processing units (RPUs). More specifically, the present disclosure relates to RPU scalable execution.

### SUMMARY

A method is provided for forming a resistive processing unit (RPU) system. The method includes forming a plurality of RPU tiles, and forming a plurality of RPU chips from the plurality of RPU tiles. The method further includes forming a plurality of RPU compute nodes from the plurality of RPU chips; and connecting the plurality of RPU compute nodes by a high speed and low latency network, forming a plurality of RPU supernodes.

An RPU system is provided. The system includes a plurality of RPU tiles and a plurality of RPU chips, whereby each RPU chip comprises the plurality of RPU tiles The RPU system further includes a plurality of RPU compute nodes, each RPU compute node having a plurality of RPU chips; and a plurality of RPU supernodes, each RPU supernode being a collection of RPU compute nodes, wherein the collection of RPU compute nodes is connected by a high speed and low latency network.

A computer program product for training an RPU system is provided. The computer program product includes a computer-readable storage medium having computer-readable program code embodied therewith. When executed, the computer-readable program code causes the computer to receive at an input layer an activation value from an external source, compute a vector matrix multiplication; and perform non-linear activation on the computed vector matrix. Based on reaching a last input layer, the computer performs backpropagation of the matrix and updates a weight matrix.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a simplified diagram of a resistive processing unit (RPU) chip;

FIG. 2 depicts various configurations of RPU chips;

FIG. 3 depicts a simplified model of an artificial neural network (ANN);

FIG. 4 depicts developing, training and using an ANN architecture comprising crossbar arrays of two-terminal, non-liner RPU tiles according to the present disclosure;

FIG. 5 depicts an exemplary hierarchical calculation on an RPU chip according to one or more embodiments of the present disclosure; and

FIG. 6 depicts a flow diagram illustrating a methodology according to one or more embodiments of the present disclosure.

### DETAILED DESCRIPTION

Training artificial neural networks (ANN) is computationally intensive, even when executing in distributed multi-node parallel computing architectures. Current implementations attempt to accelerate the computing power available to the training by packing larger numbers of computing units, such as GPUs and FPGAs into a fixed area and power budget. However, these are digital approaches that use a similar underlying technology. Therefore, acceleration factors will eventually reach a limit due to limitations on scaling in the technology.

Instead of utilizing the traditional digital model of manipulating zeros and ones, ANNs create connections between processing elements that are substantially the functional equivalent of the physical neural network that is being approximated. For example, a physical neural network can include several neurons that are connected to each other by synapses. The RPU chip approximates this physical construct by being a configuration of several RPU tiles. Each RPU tile is a crossbar array formed of a set of conductive row wires and a set of conductive column wires formed to intersect the set of conductive row wires. The intersections can be considered analogous to synapses, where the row and column wires may be analogous to the neuron connections. Each intersection is an active region that effects a non-linear change in a conduction state of the active region. The active region is configured to locally perform a data storage operation of a training methodology based at least in part on the non-linear change in the conduction state. The active region is further configured to locally perform a data processing operation of the training methodology based at least in part on the non-linear change in the conduction state.

The RPU tiles are configured together through physical connections, such as cabling, and under the control of firmware, as an RPU chip. On-chip network routers perform communications among the individual RPU tiles.

Each array element on the RPU tile receives a variety of analog inputs, in the form of voltages. Based on prior learning, i.e., previous computations, the RPU tile uses a non-linear function to determine the result to pass along to the next set of compute elements. RPU tiles are configured into RPU chips, which can provide improved performance with less power consumption because both data storage and computations are performed locally on the RPU chip. The vector computation results are passed through the RPU tiles on the RPU chips, but not the weights. Additionally, in contrast to traditional digital CPU-based computing, RPU chips are analog resistive devices, meaning computations can be performed without converting data from analog to digital, and without moving the data from the CPU to computer memory and back, as in traditional digital CPU-based computing. Because of these characteristics, computations on the RPU tile and computer chip characteristics are asynchronous and parallel execution at each layer.

FIG. 1 depicts a simplified diagram of an exemplary RPU chip. Each RPU chip includes multiple RPU tiles 140, I/O connections 110, a bus or network on chip (NoC) 130, and non-linear functions (NLF) 120.

Each RPU tile 140 includes neural elements that can be arranged in an array, for example in a 4,096-by-4,096 array. The RPU tile 140 executes the three atomic matrix operations of the forward cycle, backward cycle, and matrix update.

The I/O connections 110 communicate to other hardware components in the cluster, including other RPU chips, to return results, ingest training data, and generally to provide connectivity to other hardware in the configuration.

The NoC 130 moves data between the RPU tiles 140 and the NLFs 120 for linear and non-linear transformations. However, only the neuron data, i.e., the vectors, move but the weight data 150 remains local to the RPU tile 140.

The ANNs are composed of stacking multiple layers (convolutional, fully connected, recurrent etc.) such that the signal propagates from input layer to output layer by going through transformations by the NLFs 120. For each input and output layer, the NLFs 120 transmit the result vector from the array into the RPU tile 140, and returns the result vector from the RPU tile 140. The choice of NLF 120, for example softmax and sigmoid, depends on the requirement of the model being trained. The ANN expresses a single differentiable error function that maps the input data on to class scores at the output layer. Most commonly, the neural network is trained with simple stochastic gradient decent (SGD), in which the error gradient with respect to each parameter is calculated using the backpropagation algorithm. The backpropagation algorithm is composed of three cycles, forward, backward and weight update that are repeated until a convergence criterion is met. Once the information reaches the final output layer, the error signal is calculated and backpropagated through the neural network. Finally, in the update cycle the weight matrix is updated by performing an outer product of the two vectors that are used in the forward and the backward cycles

FIG. 2 depicts various RPU configurations. RPU chip 200, discussed previously with reference to FIG. 1, is configured from RPU tiles 140.

A compute node, such as the RPU compute node 210, includes several RPU chips 200. The CPUs (or GPUs) execute computer support functions. For example, the operating system manages and controls traditional hardware components in the RPU compute node 210, and is enhanced with firmware that also controls the RPU chips 200 and RPU-related hardware. The RPU compute node 210 also includes an RPU-aware software stack, that includes a runtime for resource management, workload scheduling, and power/performance tuning. An RPU-aware compiler generates RPU instruction set architecture (ISA)-specific executable code. An application that exploits the RPU hardware can include various RPU APIs and RPU ISA specific instructions. However, the application can include traditional non-RPU APIs and instructions, and the RPU-aware compiler can generate both RPU and non-RPU executable code.

The RPU SuperNode 220 is a collection of RPU compute nodes 210 that are connected using a high speed and low latency network, for example, InfiniBand.

The RPU system 230 illustrates only one of several possible RPU hardware configurations. As shown, symmetry is not required in an RPU system 230, which can be an unbalanced tree. The number and type of RPU hardware components in the configuration depend upon the requirements of the ANN model being trained. Some, or all, of the nodes in an RPU system 230 can be physical hardware and software. The RPU compute nodes 210 of the RPU system 230 can include virtualized hardware and software that simulate the operation of the physical hardware and software. Whether physical, virtualized, or a combination of the two, the RPU compute nodes 210 may be operated and controlled by clustering software that is specialized to coordinate and control the operation of multiple computing nodes.

Various configurations of the hardware components shown in FIG. 2 are constructed based on the requirements of the model being trained, for example, by adding more RPU chips 200 to an RPU compute node 210 or more RPU compute nodes 210 to the RPU system 230. The complexity of the model being trained, and the desired levels of performance and throughput may be contributing factors when determining the scheduling and distribution of the workload to the RPU system 230. A system administrator may tune the power consumption and performance characteristics of each RPU compute node 210, and the RPU system 230, through operating system configuration parameters on each of the RPU compute nodes 210. Depending on the RPU-aware instructions issued by the application, the operating system workload scheduling component distributes the workload among the RPU compute nodes 210 for execution.

FIG. 3 depicts a simplified ANN model 300 organized as a weighted directional graph, wherein the artificial neurons are nodes (e.g., 302, 308, 316), and wherein weighted directed edges (e.g., m1 to m20) connect the nodes. ANN model 300 is organized such that nodes 302, 304, 306 are input layer nodes, nodes 308, 310, 312, 314 are hidden layer nodes and nodes 316, 318 are output layer nodes. Each node is connected to every node in the adjacent layer by connection pathways, which are depicted in FIG. 3 as directional arrows having connection strengths m1 to m20. Although only one input layer, one hidden layer and one output layer are shown, in practice, multiple input layers, hidden layers and output layers may be provided.

Each input layer node 302, 304, 306 of ANN 300 receives inputs x1, x2, x3 directly from a source (not shown) with no connection strength adjustments and no node summations. Accordingly, y1=f(x1), y2=f(x2) and y3=f(x3), as shown by the equations listed at the bottom of FIG. 3. Each hidden layer node 308, 310, 312, 314 receives its inputs from all input layer nodes 302, 304, 306 according to the connection strengths associated with the relevant connection pathways. Thus, in hidden layer node 308, y4=f(m1*y1+m5*y2+m9*y3), wherein * represents a multiplication. A similar connection strength multiplication and node summation is performed for hidden layer nodes 310, 312, 314 and output layer nodes 316, 318, as shown by the equations defining functions y5 to y9 depicted at the bottom of FIG. 3.

ANN model 300 learns by comparing an initially arbitrary classification of an input data record with the known actual classification of the record. Using a training methodology known as backpropagation (i.e., backward propagation of errors), the errors from the initial classification of the first input data record are fed back into the network and is used to modify the network's weighted connections the second time around. This feedback process continues for several iterations. In other words, the new calculated values become the new input values that feed the next layer. This process continues until it has gone through all the layers and determined the output. In the training phase of an ANN, the correct classification for each record is known, and the output nodes can therefore be assigned correct values. For example, a node value of “1” (or 0.9) for the node corresponding to the correct class, and a node value of “0” (or 0.1) for the others. It is thus possible to compare the network's calculated values for the output nodes to these correct values, and to calculate an error term for each node (i.e., the delta rule). These error terms are then used to adjust the weights in the hidden layers so that in the next iteration the output values will be closer to the correct values.

FIG. 4 depicts developing, training and using an ANN architecture comprising crossbar arrays of two-terminal RPU devices 140 according to the present disclosure. FIG. 4 depicts a starting point for designing an ANN. In effect, FIG. 4 is an alternative representation of the ANN diagram shown in FIG. 3. As shown in FIG. 4, the input neurons, which are x₁, x₂ and x₃ are connected to hidden neurons, which are shown by sigma (σ). Weights, which represent a strength of connection, are applied at the connections between the input neurons/nodes and the hidden neurons/nodes, as well as between the hidden neurons/nodes and the output neurons/nodes. The weights are in the form of a matrix. As data moves forward through the network, vector matrix multiplications are performed, wherein the hidden neurons/nodes take the inputs, perform a non-linear transformation, and then send the results to the next weight matrix. This process continues until the data reaches the output neurons/nodes. The output neurons/nodes evaluate the classification error, and then propagate this classification error back in a manner similar to the forward pass. This results in a vector matrix multiplication being performed in the opposite direction. For each data set, when the forward pass and backward pass are completed, a weight update is performed. Basically, each weight will be updated proportionally to the input to that weight as defined by the input neuron/node and the error computed by the neuron/node to which it is connected.

FIG. 5 depicts an exemplary ANN training calculation 500 performed on an RPU chip 200 that comprises multiple RPU tiles 140, such as those depicted in FIGS. 1 and 2.

As shown in 500, the non-linear function, softmax, is used to train the ANN model. The “P” values represent weights for each layer, and x₁ represents the activation value input to the calculation at the first layer. The first layer of the forward cycle, 505, computes a vector-matrix multiplication (y=Wx) where the vector x represents the activities of the input neurons and the matrix W stores the weight values between each pair of input and output neurons.

In the example, 505 the NLF softmax operates on the local weight matrix ¹P to output a vector matrix ¹F₁. In the next layer 510, vector matrix ¹F₁ now becomes the input to softmax NLF, which operates on that layer's local weight matrix ²P to output a vector matrix ²F₁. Finally, in the last layer 515, vector matrix ²F₁ becomes the input to the softmax NLF, which operates on that layer's local weight matrix ³P, to output a vector matrix ³F₁.

Following the calculation of final output layer 515, the error signal is calculated and backpropagated through the network. The backward cycle on a single layer also involves a vector-matrix multiplication on the transpose of the weight matrix (z=W^{T}δ), where the vector δ represents the error calculated by the output neurons. Finally, in the update cycle the weight matrix W is updated by performing an outer product of the two vectors that are used in the forward and the backward cycles and usually expressed as W←W+η(δx^{T}) where η is a global learning rate.

Each operation 505, 510, 515 can occur in a pipeline paralleled fashion, thereby fully utilization the RPU hardware in all three cycles of the training algorithm.

FIG. 6 depicts a methodology of training an RPU configuration according to one or more embodiments of the present disclosure.

As shown in FIGS. 3-4, an RPU tile 140 is comprised of a trainable crossbar array, whereby each RPU tile 140 locally performs one or more data storage operations of a training methodology. The array can include one or more input layer, one or more hidden internal layers, and one or more output layers.

At 605, the RPU tile 140 receives from an outside source an activation input value, e.g., x1, at an input layer. At 610, the RPU tile 140 computes a vector-matrix multiplication, where the vector represents the activities of the input neurons and the weight matrix W stores the weight values between each pair of input and output neurons. Storing the weight matrix locally, allows computations that are pipeline parallel and asynchronous. At 615, non-linear activation is performed on each element of the resulting vector y, and the resulting vector is passed to the next layer (620). If this current layer is not the last input layer (625), then the resulting vector of the current layer, here ¹F₁ of 505, is passed as input to the next layer (630). At the next layer, the computation is repeated using the weight matrix (²P₁) that is stored on the RPU tile 140 locally to the layer. The process returns to 615, as is repeated for each input layer.

If, at 625, the last layer is reached (e.g., 515 of FIG. 5), then at 635 the error signal is calculated and backpropagated through the network. At 640, the backward cycle on a single layer is performed with a vector-matrix multiplication on the transpose of the weight matrix (z=W^{T}δ), where the vector δ represents the error calculated by the output neurons. In the example of FIG. 5, the start of backpropagation is represented by 515. The result of the last input layer, ³F₁, becomes the activation input of the backpropagation algorithm, ⁴B₁. The softmax non-linear function performs vector-matrix computation locally on the RPU tile 140 using the activation input and the weight matrix ³P₁ (645). The resulting vector, ⁴B₁ is passed upward to the next layer (650). If this is not the last output layer (655), the process continues at 640. In this case, the output from 515, ³B₁ becomes the activation input, and the calculation is performed locally on the weight matrix ²P₁, the resulting vector matrix being ²B₁. This process continues until the last output layer is reached.

When the last output layer is reached, the weight matrix W is updated by performing an outer product of the two vectors that are used in the forward and the backward cycles, as shown in the update column 555 of FIG. 5.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for forming a resistive processing unit (RPU) system, comprising:
forming a plurality of RPU tiles;
forming a plurality of RPU chips from the plurality of RPU tiles;
forming a plurality of RPU compute nodes from the plurality of RPU chips; and
connecting the plurality of RPU compute nodes by a high speed and low latency network, forming a plurality of RPU supernodes.

2. The method of claim 1, wherein forming a plurality of RPU tiles further comprises:
forming a set of conductive row wires;
forming a set of conductive column wires configured to intersect the set of conductive row wires, wherein each intersection is an active region having a conduction state;
configuring the active regions of each of the plurality of RPU tiles to locally perform a data storage operation of an artificial neural network training methodology; and
configuring the active regions of each of the plurality of RPU tiles to locally perform a data processing operation of the artificial neural network training methodology.

3. The method of claim 1, wherein forming the plurality of RPU chips further comprises:
forming the plurality of RPU tiles;
configuring a non-linear function;
configuring a non-linear bus between each of the plurality of RPU tiles and the non-linear function; and
configuring a communication path between each RPU chip and computing components external to the RPU chip.

4. The method of claim 1, wherein the plurality of RPU compute nodes comprise a combination of virtualized hardware and software.

5. The method of claim 1, wherein the plurality of RPU compute nodes comprise physical hardware and software.

6. The method of claim 1, further comprising:
computing a first matrix result vector forward from an input layer through each layer of a matrix to an output layer of the matrix;
computing a second matrix result vector backward from the output layer through each layer of the matrix to the input layer of the matrix; and
updating a weight matrix using an outer product of the first matrix result vector and the second matrix result vector.

7. The method of claim 6, wherein computing the first matrix result vector, computing the second matrix result vector, and the updating the weight matrix are performed asynchronously and in pipeline paralleled fashion.

8. The method of claim 6, wherein computing the first matrix result vector, computing the second matrix result vector, and the updating the weight matrix are each an atomic operation.

9. An RPU system, comprising:
a plurality of RPU tiles;
a plurality of RPU chips, wherein each RPU chip comprises the plurality of RPU tiles;
a plurality of RPU compute nodes, each RPU compute node having a plurality of RPU chips; and
a plurality of RPU supernodes, each RPU supernode being a collection of RPU compute nodes, wherein the collection of RPU compute nodes is connected by a high speed and low latency network.

10. The RPU system of claim 9, wherein each of the plurality of RPU tiles further comprises:
a trainable crossbar array of fully connected layers comprising a set of conductive row wires and a set of conductive column wires formed to intersect the set of conductive row wires, wherein each intersection is an active region having a conduction state.

11. The RPU system of claim 10, wherein the active region performs a data storage operation of an artificial neural network training methodology locally on the RPU tile; and
wherein the active region performs a data processing operation of the artificial neural network training methodology local on the RPU tile.

12. The RPU system of claim 9, wherein the plurality of RPU chips further comprises:
the plurality of RPU tiles;
a non-linear function;
a non-linear bus between each of the plurality of RPU tiles and the non-linear function; and
a communication path between each RPU chip and computing components external to each of the plurality of RPU chips.

13. The RPU system of claim 9, wherein the plurality of RPU compute nodes comprise a combination of virtualized hardware and software.

14. The RPU system of claim 9, wherein the plurality of RPU compute nodes comprise physical hardware and software.

15. A computer program product for training an RPU system, comprising a computer-readable storage medium having computer-readable program code embodied therewith, the computer-readable program code when executed on a computer causes the computer to:
receive at an input layer an activation value from an external source;
compute a vector matrix multiplication;
perform non-linear activation on the computed vector matrix;
based on reaching a last input layer, perform backpropagation of the matrix; and
update a weight matrix.

16. The computer program product of claim 15, further comprising:
program instructions to compute a first matrix result vector forward from an input layer through each layer of a matrix to an output layer of the matrix;
program instructions to compute a second matrix result vector backward from the output layer through each layer of the matrix to the input layer of the matrix; and
program instructions to update a weight matrix using an outer product of the first matrix result vector and the second matrix result vector.

17. The computer program product of claim 16, further comprising asynchronous and parallel computation of the first matrix result vector, the second matrix result vector, and the updating of the weight matrix.

18. The computer program product of claim 16, wherein the first matrix result vector computing, the second matrix result vector computing, and the weight matrix updating are each an atomic operation.

19. The computer program product of claim 15, wherein the active region performs a data storage operation of an artificial neural network training methodology locally on the RPU tile.

20. The computer program product of claim 15, wherein the active region performs a data processing operation of the artificial neural network training methodology local on the RPU tile.
